(19) United States
(12) Patent Application Publication
(10) Pub. No.: US 2014/0317062 A1
(43) Pub. Date: Oct. 23, 2014

(54) AMETHOD AND APPARATUS FOR RECOVERING SQLITE FILE DELETED FROM MOBILE TERMINAL

(71) Applicant: XIAMEN MEIYA PICO INFORMATION CO. LTD., FUJIAN (CN)

(72) Inventors: Yanying Xue, Fujian (CN); Yibin Lin, Fujian (CN)

(21) Appl. No.: 14/359,930

(22) PCT Filed: Jan. 10, 2013
(86) PCT No.: PCT/CN2013/070316

§ 371 Date: May 22, 2014

(30) Foreign Application Priority Data
Oct. 30, 2012 (CN) 201210430026.0

(51) Int. Cl. G06F 11/14

(52) U.S. Cl. CPC G06F 11/1458
USPC 707/674

(57) ABSTRACT

The invention provides a method and device to recover deleted sqlite files on mobile terminal. The invention provides a method to preset several sqlite page feature rules. Perform following steps when a mobile terminal is detected: obtaining the image files of current mobile terminal; analyzing the image files of current mobile terminal and selling the search area; call at least one preset sqlite page feature rule according to the data features in the search area, and matching with the data in the search area based on the said sqlite page feature rule to capture the current sqlite page file fragment deleted by the mobile terminal; finally, decoding the data of sqlite page file fragment deleted on current mobile terminal. The invention provides a solution to obtain valid data from the uncovered page fragment of all deleted sqlite files in the mobile terminal, with a high recovery success rate and integrity.

### BACKGROUND OF THE INVENTION

The invention relates to the technical field of data recovery, particular to a method and device to recover deleted sqlite files of mobile terminal.

Electronic data recovery refers to rescue and recover technically the lost electronic data that have been originally stored in storage media such as hard disks of desktop, notebook and server, storage tape libraries, mobile hard disks and digital memory cards. Data recovery plays a particularly important role in electronic data forensics.

Currently, regarding iOS mobile intelligent terminals, problems often arise during electronic data forensics, such as failing to get user contact and messages as users have deleted applications of QQ, Fetion and Weibo from the terminal. Most of the data are stored in sqlite files and the number of files recovered from the file system is limited.

Currently, for damaged MT that can still start and operate normally, relevant data storage files shall be extracted according to the communications protocol provided on mobile terminal and further deleted sqlite files shall be recovered. But this method is only used in recovering data which is still stored in storage files, for example, as to users delete records by using common method, these deleted records are only marked as deleted state, but in fact the records are still stored in the original file for keeping records. Therefore, for the method to extract relevant data storage files according to the communications protocol provided on mobile terminal, the prerequisite of correct data recovery is that the original file for keeping records is not be deleted. Obviously, if application programs of data file itself are unloaded or object files are deleted by other auxiliary communication tools, the object files cannot be recovered.

### BRIEF SUMMARY OF THE INVENTION

The invention provides a method and device to recover deleted sqlite files on mobile terminal, used for solving problems that sqlite files of deleted application on the mobile terminal are unable to be recovered by existing technology. The invention provides a solution to capture the valid data in uncovered page fragments of all deleted sqlite files in the mobile terminal, with a high recovery success rate and integrity.

The invention provides a method to restore deleted sqlite files on mobile terminal, including: to preset several sqlite page feature rules and perform the following steps when the mobile terminal is detected: firstly, capture current image files of mobile terminal; afterwards, analyze image files of current mobile terminal and set the search area; call and match at least one preset sqlite page feature rule according to the data characteristics in the search area to capture the current sqlite page file fragment deleted by the mobile terminal; finally, decode the data of the current sqlite page file fragment deleted by the mobile terminal and recover the current sqlite file data deleted by the mobile terminal.

Preferably, in the above methods, analyzing image files of current mobile terminal and setting the search area include: judging if it is possible to analyze image files of the current mobile terminal, if yes, capturing the unallocated cluster region of image files of current mobile terminal and taking it as the search area, otherwise, taking full image files of current mobile terminal as a search area.

Preferably, in the above methods, the said calling at least one preset sqlite page feature rule according to the data characteristics in the said search area, and matching with the data in the said search area based on the said sqlite page feature rule to capture the current sqlite page file fragment deleted by the mobile terminal, further include: setting a search block whose size is as much as sqlite page. At this moment, the said matching with the data in the said search area based on the sqlite page feature rule includes: blocking the said search area based into search blocks, and matching with the data of all search blocks in the search area based on each called sqlite page feature rule and preset search sequence respectively.

Preferably, in the above methods, wherein as for each called sqlite page feature rule, the said matching with the data of all search blocks in the search area based on the preset search sequence includes:

Step A: scan the first search block based on the preset search sequence;

Step B: judging if the head characteristic of the current search block is the sqlite page head characteristic specified by the called sqlite page feature rule;

Step C: judging if the data of the current search block is possible to be matched with the data characteristic specified by the called sqlite page feature rule, if outputting the data in the current search block and performing step D, otherwise, performing step B;

Step D: judging if all search blocks in the search area are matched based on the said preset search sequence, if yes, ending the data matching process against the current called sqlite page feature rule, otherwise, performing Step E;

Step E: scanning the next search block according to the said preset search sequence and taking the next search block as the current search block, and going back to perform Step 8.

Preferably, in the above methods, the said decoding the data of the sqlite page file fragment deleted by the current mobile terminal and recovering the sqlite file data deleted by the current mobile terminal, include: decoding the useful information in sqlite file page fragment deleted by the current mobile terminal, and identifying the relations between each piece of useful information to capture the valid data information, wherein the useful information includes the sheets, fields and records in the deleted sqlite file page fragment; the said valid data information includes the uncovered database management information and database data in the deleted sqlite file page fragment.

The invention provides a device to recover deleted sqlite files by terminal, comprising an image capturing unit, an image analysis unit, a page rule call unit, a first page rule match unit, a second page rule match unit . . . a Nth page rule match unit and a sqlite analysis unit, wherein the said N is a positive integer greater than or equal to 2; a sqlite page feature rule is prestored on each page rule match unit from the said first page rule match unit to the Nth page rule match unit, and the sqlite page feature rules stored in any two page rule match units from the said first page rule match unit to the Nth page rule match unit are different; the said image capturing unit is used for capturing image files of current mobile terminal and providing them to the said image analysis unit; the said image analysis unit is used for analyzing image files of the said current mobile terminal, setting the search area and providing image files of the said current mobile terminal and the set search area for the said page rule call unit; the said page rule call unit is used for calling at least one page rule match unit from the said first page rule match unit to the Nth page rule match unit based on the said data in the search area, and providing the said search area to each called page rule match unit; each page rule match unit called by the said page rule call unit is used for matching with the data in the said search area based on the self-stored sqlite page feature rules, to capture the sqlite file page fragment deleted by the current mobile terminal and providing to the said sqlite analysis unit; the said sqlite analysis unit is used for decoding the received data of the sqlite page file fragment deleted by the current mobile terminal and recovering the sqlite file data deleted by the current mobile terminal.

Preferably, when the said image analysis unit is possible to analyze image files of the said current mobile terminal, the said image resolution requires the unallocated cluster region of image files of current mobile terminal and setting it as the said search area, otherwise, the said image analysis unit takes the full image file of the current mobile terminal as the search area.

Preferably, the said image analysis unit is used for setting a search block with the same size as the system file block of current mobile terminal, and providing the search block to the said page rule call unit; the said page rule call unit is further used for providing the said received search block for each called page rule match unit; each page rule match unit called by the said page rule call unit is first used for blocking the said search area into search blocks, and then matching with the data in the said search area based on the self-stored sqlite page feature rules and preset search sequence.

Preferably, the said sqlite analysis unit is further used for decoding the useful information in the sqlite file page fragment deleted by the current mobile terminal to capture the valid data information, wherein the useful information includes the sheets, fields and records in the deleted sqlite file page fragment; the said valid data information includes the uncovered database management information and database data in the deleted sqlite file page fragment.

Compared with the existing technology, the technical program provided in the invention is based on recovering page file fragment for sqlite files of deleted application on mobile terminal image files, which is not limited to the deleted sqlite files, but to capture the valid data in uncovered page fragments of all deleted sqlite files in the mobile terminal, with a high recovery success rate and integrity.

### BRIEF DESCRIPTION OF THE DRAWINGS

FIG. 1 is a flowchart of the method to recover deleted ape files on mobile terminal provided by the embodiment of the invention;

FIG. 2 is an example of the method to search an unallocated cluster region of image files of current mobile terminal for capturing page btree provided by the invention;

FIG. 3 is a structural schematic diagram of the device to recover deleted sqlite files on mobile terminal provided by the embodiment of the invention;

FIG. 4A is a diagram of partial data in the file before a mobile terminal deleting sqlite files;

FIG. 4B is the corresponding sqlite file data recovered by the program of the invention after deleting the sqlite files of mobile terminal showed in FIG. 4A.

### DETAILED DESCRIPTION OF THE INVENTION

The invention implementation is described as follows and with enclosed figures:

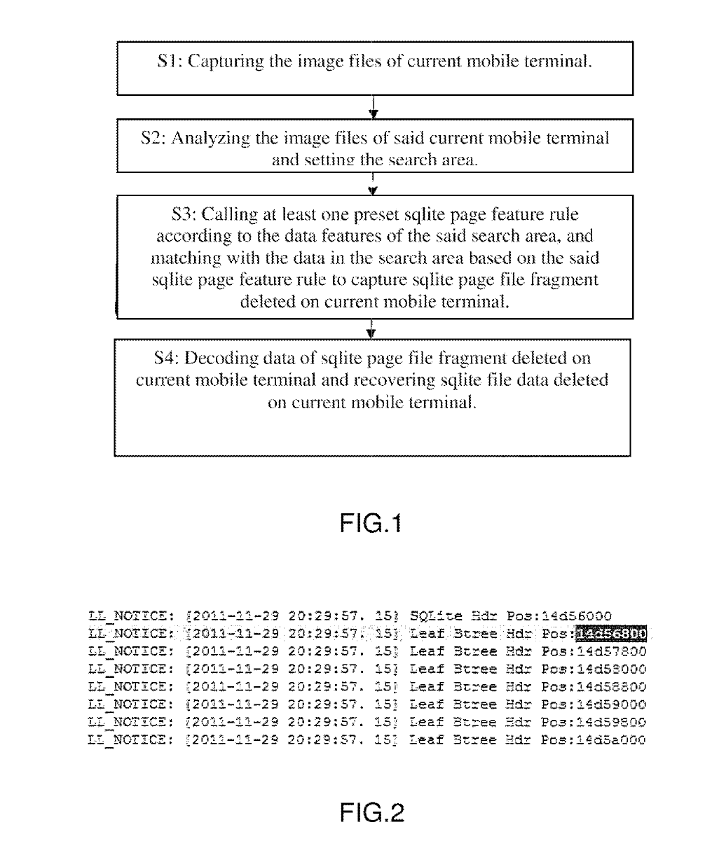

FIG. 1 is a flowchart of method to recover deleted sqlite files on mobile terminal provided by the embodiment of invention, including:

S1: Capture the image files of current mobile terminal; if the image files of current mobile terminal can not be captured in this step, end the process directly.

S2: analyzing the image files of said current mobile terminal and setting the search area; in this step, firstly judging if the preset resolution method is possible to analyze the image files of current mobile terminal, if yes, capturing the unallocated cluster region of image files of current mobile terminal and taking it as the search area, otherwise, taking the full image files of current mobile terminal as the search area. The full image files of said current mobile terminal is the whole image files of current mobile terminal.

S3: calling at least one preset sqlite page feature rule according to the data features in the said search area, and matching with the data in the search area based on the said sqlite page feature rule to capture the sqlite page file fragment deleted by the current mobile terminal, wherein each sqlite page feature rule corresponds to one specific sqlite file page fragment, i.e., the types of sqlite file page fragment matched with the search area by any two sqlite page feature rules are different. If the search area in S2 is the unallocated cluster region of image files of current mobile terminal, the data in the unallocated cluster region of image files of current mobile terminal shall be matched with the deleted sqlite file page fragment according to the preset sqlite page feature rules; if the search area in S2 is the full image files of current mobile terminal, the data in the full image files of current mobile terminal shall be matched with the deleted sqlite file page fragment.

S4: decoding the data of sqlite page file fragment deleted by the current mobile terminal and recovering the sqlite file data deleted by the current mobile terminal.

Obviously, only if the mobile terminal of sqlite file needed to be recovered is detected, the method shown in FIG. 1 will be carried out.

Preferably, in the said method to recover deleted sqlite files, one step before S3 further includes setting a search block as according to the system file block of current mobile terminal, wherein the size of search block is set as much as that of sqlite page due to the size of system file block of mobile terminal is the integer multiples of sqlite page by default. At this case, S3 specifically includes: blocking the search area based into search blocks, matching with the data of all search blocks in the search area based on each called sqlite page feature rule respectively, to capture the sqlite file page fragment deleted by the current mobile terminal, wherein the preset sequence shall be adopted as the search sequence for blocking and matching the data in the search area, for example, a step-by-step blocking searching method shall be used to match with the data in the search area, i.e., assuming the searching region includes 2 unallocated cluster regions, with 1,024 bytes of size and setting the searching block as 512 bytes, the search area will be divided into 4 search blocks; as for the current called sqlite page feature rules, the data in all search blocks of search area shall be matched in turn according to the preset search sequence. The search sequence shall be set according to the specific requirements, not limited to the stepping type, which will not be described further.

The detailed blocking and matching process is:

Step A: scanning the first search block based on the preset search sequence;

Step B: as for the data in the current search block, judging if the head feature of current search block is the sqlite page head feature specified by the called sqlite page feature rule, if yes, performing step C, otherwise, performing step E.

Step C: judging if the data of current search block is possible to be matched with the data feature specified by the called sqlite page feature rule, if yes, outputting the data in the current search block and performing step D, otherwise, performing step E;

Step D: judging if all search blocks in the search area are matched based on the said preset search sequence, if yes, ending the data matching process against the current called sqlite page feature rule to capture the deleted sqlite file page fragment against the current called sqlite page feature rule made up by the data in several search block in the search area, otherwise, performing step E;

Step E: scanning the next search block according to the said preset search sequence and taking the next search block as the current search block, and going back to perform step 8.

In the above process, although the head features of data in the current search block is judged as the same as the sqlite page head features of current called sqlite page feature rules in step B, the data corresponding to the head feature may not be the sqlite page data, but may also be the fragment of other file types (such as doc, png and excel), therefore if the head feature of data in the current search block is the sqlite page head feature specified by the current sqlite page feature rule, it is necessary to further judge if the data feature of current search block corresponding to the current search block is possible to be matched with the data feature specified by the called sqlite page feature rule, if yes, the head feature and all corresponding data thereof make up a sqlite file page fragment. For example: since the btree page is the page for storing data in sqlite files, type of the sqlite file page fragment to be captured in S3 is mainly btree leaf page. Specifically as shown in following Table 1: the type of btree page will be marked in the page head of btree page.

TABLE 1

| Offset | Size | Description |
|---|---|---|
| 0 | 1 | Flag bit of btree page type, wherein except 2: internal |
| | | key value page, 5: internal sheet page, 10: leaf key value |
| | | page and 13: leaf sheet page, other values are illegal. |
| 1 | 2 | Offset of the first free block |
| 3 | 2 | Unit number in the page |
| 5 | 2 | Initial position of unit content |
| 7 | 1 | Number of fragment bytes |
| 8 | 4 | Number of right-most son page (only valid for internal |
| | | page, such field does not exist in leaf page) |

Therefore, when the unallocated cluster region of the image file of current mobile terminal or the full image file of the current mobile terminal is matched with page fragments by using the set search block, page heads of btree page are usually located in the initial position of the first search block; after capturing the content of the first search block which meets the properties of btree page head, further data verification of taking search block as a unit shall be carried out for the later data meeting properties of btree page head and next to the first search block according to the preset sequence, and finally judge if the data of the region is legal btree page. The matching method of other types of pages is similar to that of btree page; it is not repeated herein. FIG. 2 is an example of the method to search an unallocated cluster region of the image files of current mobile terminal for capturing page b&'ee provided by the invention.

Preferably, the said step S4 specifically includes: decoding the useful information in sqlite file page fragment deleted by the current mobile terminal, and identifying the relations between each piece of useful information to capture the valid data information. Wherein, the useful information includes the sheets, fields and records in the deleted sqlite file page fragment; the valid data information includes the uncovered database management information and database data in the deleted sqlite file page fragment Here the captured data information is used for data reconstruction of follow-up sqlite files. Due to the invention aiming at providing a method to recover deleted sqlite files of mobile terminal instead of providing a process to reconstruct the recovered sqlite files, thus here do not describe the purpose of using the program provided by the invention to capture the deleted sqlite files of mobile terminal any more.

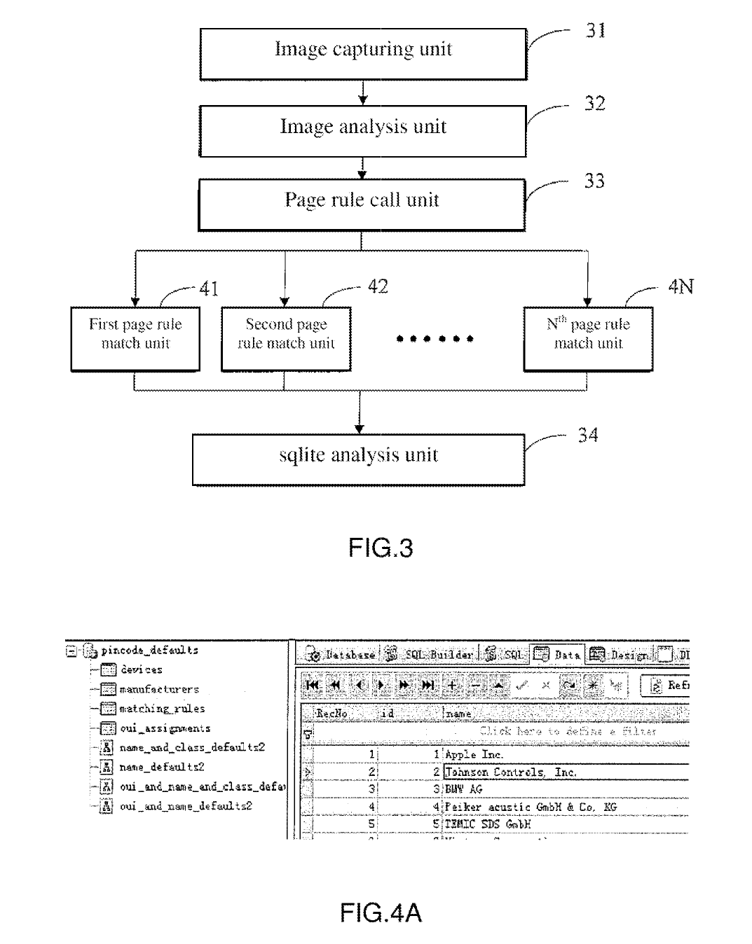

For the said method, the embodiment of the invention further provides a device to recover deleted sqlite files on mobile terminal as shown in FIG. 3, which further comprises an image capturing unit 31, an image analysis unit 32, a page rule call unit 33, a first page rule match unit 41, a second page rule match unit 42 . . . a Nth page rule match unit 4N and a sqlite analysis unit 34, wherein the N is a positive integer greater than or equal to 2; a sqlite page feature rule is prestored in each page rule match unit from the first page rule match unit 41 to the Nth page rule match unit 4N, and the sqlite page feature rules stored in any two page rule match units from the first page rule match unit 41 to the Nth page rule match unit 4N are different;

Image capturing unit 31 is used for capturing image files of the current mobile terminal and providing them to image analysis unit 32; Image capturing unit 31 is used for analyzing image files of current mobile terminal, setting the search area and providing image files of current mobile terminal and the set search area for the page rule call unit 33; wherein, when image analysis unit 33 is possible to analyze image files of current mobile terminal, image analysis unit 32 captures the unallocated cluster region of image files of current mobile terminal and setting it as the said search area, otherwise. image analysis unit 32 takes full image file of the current mobile terminal as the search area. The page rule call unit 33 is used for calling at least one page rule match unit from the first page rule match unit 41 to the N page rule match unit 4N based on the data in the search area, and providing the search area to each called page rule match unit; each page rule match unit called by the said page rule call unit is used for matching with the data in the search area based on the self-stored sqlite page feature rules, to capture the sqlite file page fragment deleted by the current mobile terminal and providing to the sqlite analysis unit 34; the sqlite analysis unit 34 is used for decoding the received data of the sqlite page file fragment deleted by the current mobile terminal and recovering the sqlite file data deleted by the current mobile terminal.

Preferably, the image analysis unit 32 is used for setting a search block whose size is as much as the sqlite page, and providing the search block to the page rule call unit 33; the page rule call unit 33 is further used for providing the received search block for each called page rule match unit; each page rule match unit called by the page rule call unit is first used for blocking the search area into search blocks, and then matching with the data in the search area based on the self-stored sqlite page feature rules and preset search sequence.

Preferably, the sqlite analysis unit 34 is further used for decoding the useful information in the sqlite file page fragment deleted by the current mobile terminal to capture the valid data information, wherein the useful information includes the sheets, fields and records in the deleted sqlite file page fragment; the said valid data information includes the uncovered database management information and database data in the deleted sqlite file page fragment.

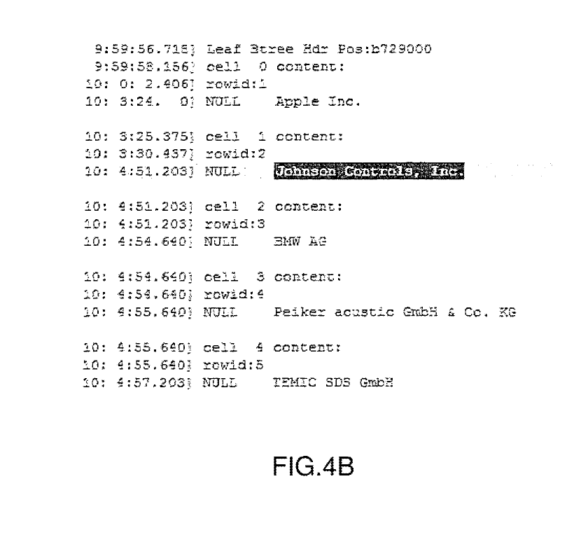

FIG. 4A is the partial data in the file before sqlite files deleted on a mobile terminal; FIG. 4B is the sqlite file recovered by the program of the invention after deleting the sqlite files of mobile terminal showed in FIG. 4A, which is corresponding to the sqlite file of the part showed on FIG. 4A. Obviously, using the program provided by the embodiment of the invention can completely recover the data in deleted sqlite files of mobile terminal.

The said program to recovery sqlite files provided by the embodiment of the invention is used for recovering data of any intelligent terminal by using storage data of sqlite database. The program is based on recovering page file fragment for sqlite files of deleted application on mobile terminal image files, which is not limited to the deleted sqlite files, but to capture the valid data in uncovered page fragments of all deleted sqlite files in the mobile terminal, with a high recovery success rate and integrity as well as strong applicability.

Obviously, technical person in the field may make various modifications and alterations without departing from the spirit and scope of the invention. Thus, if the invention modifications and variations belong to the range of the Claims for the invention and their equivalent technology, the invention is also intended to include these changes and modifications.

What is claimed is:

1. A method to recover deleted sqlite files of mobile terminal is featured with that several sqlite page feature rules are preset. Perform following steps when a mobile terminal is detected:
Capture the image files of current mobile terminal;
Analyze the image files of said current mobile terminal and set the search area;
Call at least one preset sqlite page feature rule according to the data features of the said search area, and match with the data in the said search area based on the said sqlite page feature rule to capture sqlite page file fragment deleted on the current mobile terminal;
Decode the data of sqlite page file fragment deleted on the current mobile terminal and recovering the sqlite file data deleted on the current mobile terminal.

2. The method described in claim 1 to recover deleted sqlite files on mobile terminal is featured with the said image file analysis for current mobile terminal and setting search areas, including: judging if it is possible to analyze the image files on current mobile terminal, if yes, capturing unallocated cluster area of image files on current mobile terminal and taking it as the search area, otherwise, taking the full image files of current mobile terminal as the search area.

3. The method to recover deleted sqlite files of mobile terminal described in claim 1 or 2 is featured with the said calling at least one preset sqlite page feature rule according to the data features of the said search area, and matching with the data in the said search area based on the said sqlite page feature rule to capture the sqlite page file fragment deleted on the current mobile terminal, further include: setting a search block whose size is as much as sqlite page;
The said matching with the data in the said search area based on sqlite page feature rules, including: blocking the said search area based into search blocks, and matching with the data of all search blocks in the search area based on each called sqlite page feature rule and preset search sequence respectively.

4. The method described in claim 3 to recover deleted sqlite files on mobile terminal is featured with the said matching with the data of all search blocks in the search area based on the preset search sequence for each sqlite page feature rule called, including:
Step A: Scan the first search block based on the preset search sequence;
Step B: Judge if the head feature of current search block is the sqlite page head feature specified by the called sqlite page feature rule; if yes, go to Step C or go to Step E.
Step C: Judge if the data of current search block is possible to be matched with the data feature specified by the called sqlite page feature rule; if yes, output the data in the current search block and perform Step D, otherwise, perform Step E;
Step D: Judge if all search blocks in the search area are matched based on the said preset search sequence, if yes, end data matching process against the current sqlite page feature rule called, otherwise, perform Step E;
Step E: Scan the next search block according to the said preset search sequence and take the said next search block as current search block, and return to perform Step B.

5. The method to recover deleted sqlite files on mobile terminal described in claim 4 is featured with the said decoding the data of sqlite page file fragment deleted on current mobile terminal and recovering the sqlite file data deleted on the current mobile terminal, including: decoding useful information in sqlite file page fragment deleted on the current mobile terminal, and identifying the relations between each piece of useful information to capture valid data information, wherein the useful information includes tables, fields and recorded information in the deleted sqlite file page fragment; the said valid data information includes uncovered database management information and database data in sqlite file page fragment deleted.

6. A device to recover deleted sqlite files on mobile terminal, comprising an image capturing unit, an image analysis unit, a page rule call unit, a first page rule match unit, a second page rule match unit . . . a Nth page rule match unit and a sqlite analysis unit, wherein N is a positive integer greater than or equal to 2; a sqlite page feature rule is prestored in each page rule match unit from the said first page rule match unit to the Nth page rule match unit, and the sqlite page feature rules stored in any two page rule match units from the said first page rule match unit to the Nth page rule match unit are different;
The said image capturing unit is used for capturing the image files of current mobile terminal and providing them to the said image analysis unit;
The said image analysis unit is used for analyzing the image files of said current mobile terminal, setting the search area and providing the image files of said current mobile terminal and the set search area to the said page rule call unit;
The said page rule call unit is used for calling at least one page rule match unit from the said first page rule match unit to the Nth page rule match unit based on the said data in the search area, and providing the said search area to each called page rule match unit;
Each page rule match unit called by the said page rule call unit is used for matching with the data in the said search area based on the self-stored sqlite page feature rules, to capture the sqlite file page fragment deleted on the current mobile terminal and providing to the said sqlite analysis unit;
The said sqlite analysis unit is used for decoding the received data of sqlite page file fragment deleted on the current mobile terminal and recovering the sqlite file data deleted on the current mobile terminal.

7. The device to recover deleted sqlite files on mobile terminal described in claim 6 is featured with that when the said image analysis unit is possible to analyze the image files of said current mobile terminal, the said image analysis unit captures the unallocated cluster area of image files of current mobile terminal and set it as the said search area, otherwise, the said image analysis unit takes the full image files of current mobile terminal as the search area.

8. The device to recover deleted sqlite files on mobile terminal described in claim 7 is featured with that the said image analysis unit is further used for setting a search block with the same size as sqlite page and providing it for the said page rule call unit;
The said page rule call unit is further used for providing the said received search block for each called page rule match unit;
Each page rule match unit called by the said page rule call unit is first used for blocking the said search area into search blocks, and then matching with the data in the said search area based on the self-stored sqlite page feature rules and preset search sequence.

9. The device to recover deleted sqlite files on mobile terminal described in claim 8 is featured with that the said sqlite analysis unit is further used for decoding the useful information in the sqlite file page fragment deleted on the current mobile terminal to capture the valid data information, wherein the useful information includes tables, fields and records in the deleted sqlite file page fragment; the said valid data information includes uncovered database management information and database data in deleted sqlite file page fragment.
